(19) United States
(12) Patent Application Publication
(10) Pub. No.: US 2004/0140844 A1
(43) Pub. Date: Jul. 22, 2004

(54) Temperature compensated bandgap voltage references

(75) Inventor: Chik Yam Lee, Courtaboeuf Cedex (FR)

Correspondence Address: OSTROLENK FABER GERB & SOFFEN, 1180 AVENUE OF THE AMERICAS, NEW YORK, NY, 100368403

(73) Assignee: International Rectifier Corporation

(21) Appl. No.: 10/713,928

(22) Filed: Nov. 14, 2003

Related U.S. Application Data
(60) Provisional application No. 60/441,063, filed on Jan. 17, 2003.

(51) Int. Cl. G05F 1/10

(52) U.S. Cl. 327/539

(57) ABSTRACT

A bandgap voltage reference circuit comprising a first circuit providing a first voltage substantially proportional to V_{be} of a first bipolar transistor, a second circuit providing a second voltage ΔV_{be} substantially proportional to the difference of two V_{be} voltages of two bipolar transistors, and a comparator having respective inputs coupled to V_{be} and ΔV_{be} and an output coupled to the base of the first bipolar transistor whereby a voltage substantially proportional to the sum of respective constants multiplying V_{be} and ΔV_{be} is provided at the output of the comparator.

### CROSS REFERENCE TO RELATED APPLICATIONS

This application is based on and claims priority of U.S. provisional patent application Serial No. 60/441,063, filed Jan. 17, 2003, entitled TEMPERATURE COMPENSATED BANDGAP VOLTAGE REFERENCE, the entire disclosure of which is incorporated herein by reference.

### BACKGROUND OF THE INVENTION

The present invention is directed to a temperature compensated bandgap voltage reference.

FIG. 1 shows how a reference voltage based upon V_{be} of a bipolar transistor can be obtained. The current source I is provided in the emitter path of a bipolar transistor. A plurality of current sources can be provided each coupled to an FET of varying size to provide current sources of different magnitude, e.g., I, 10I, etc. as shown.

V_{be} of a bipolar transistor decreases with increasing temperature in a well-known fashion. See FIG. 3. It is also known that a current mirror can be used to obtain a voltage proportional to ΔV_{be} i.e., the difference between the V_{be} of two bipolar transistors. FIG. 2 shows such a current mirror circuit. ΔV_{be} is equal to V_{be2} minus V_{be1} and ΔV_{be} is equal to kt/q In NI/I. ΔV_{be} depends upon the ratio of the currents of the current sources as well as the temperature. In particular, ΔV_{be} increases with temperature. See FIG. 3. By combining the two circuits, it is possible to compensate V_{be} with ΔV_{be} to obtain a substantially constant reference voltage Vref as shown in FIG. 3. In particular, Vref is equal to a constant A times V_{be} plus a constant B times ΔV_{be}.

### SUMMARY OF THE INVENTION

The invention provides a new implementation of a V_{be} bandgap voltage reference that sums V_{be} and ΔV_{be} to obtain a substantially constant temperature independent voltage reference. The circuit uses a current mirror for ΔV_{be} and a bipolar transistor to provide V_{be}. A comparator is implemented as a differential amplifier and receives inputs proportional to V_{be} and Δ V_{be}. The output of the comparator is coupled back to the input of the bipolar transistor that provides V_{be}.

According to one aspect, the invention comprises a bandgap voltage reference circuit comprising a first circuit providing a first voltage substantially proportional to V_{be} of a first bipolar transistor, a second circuit providing a second voltage ΔV_{be} substantially proportional to the difference of two V_{be} voltages of two bipolar transistors; and a comparator having respective inputs coupled to V_{be} and ΔV_{be} and an output coupled to the base of the first bipolar transistor whereby a voltage substantially proportional to the sum of respective constants multiplying V_{be} and ΔV_{be} is provided at the output of the comparator.

According to another aspect, the invention comprises a bandgap voltage reference circuit comprising a first bipolar transistor providing substantially a reference voltage V_{be}, a current mirror circuit comprising two bipolar transistors coupled in a current mirror arrangement for providing a voltage difference ΔV_{be} comprising substantially a difference signal between the respective V_{be} voltages of the two bipolar transistors; and a comparator having respective inputs coupled to V_{be} and ΔV_{be} and an output coupled to the base of the first bipolar transistor whereby a voltage substantially proportional to the sum of respective constants multiplying V_{be} and ΔV_{be} is provided at the output of the comparator.

According to yet another aspect, the invention comprises a bandgap voltage reference circuit comprising a first circuit providing a first voltage substantially proportional to V_{be} of a first bipolar transistor, a second circuit providing a second voltage ΔV_{be} substantially proportional to the difference of two V_{be} voltages of two bipolar transistors, and a comparator having respective inputs coupled to V_{be} and ΔV_{be} and an output coupled to the base of the first bipolar transistor whereby a substantially temperature independent voltage refererence is provided at the output of the comparator.

### BRIEF DESCRIPTION OF THE DRAWINGS

FIG. 1 shows a prior art circuit for generating a reference voltage based on V_{be} of a bipolar transistor;

FIG. 2 shows a prior art circuit mirror circuit for generating a voltage proportional to V_{be};

FIG. 3 is a graph showing the relationship of V_{be} and ΔV_{be} and a reference voltage comprising weighted sums of V_{be} and ΔV_{be};

FIG. 4 shows the reference voltage generating circuit according to the invention;

FIGS. 5A and 5B shows waveforms of the circuit of FIG. 4; and

FIG. 6 shows a schematic diagram of an implementation of the circuit of the invention.

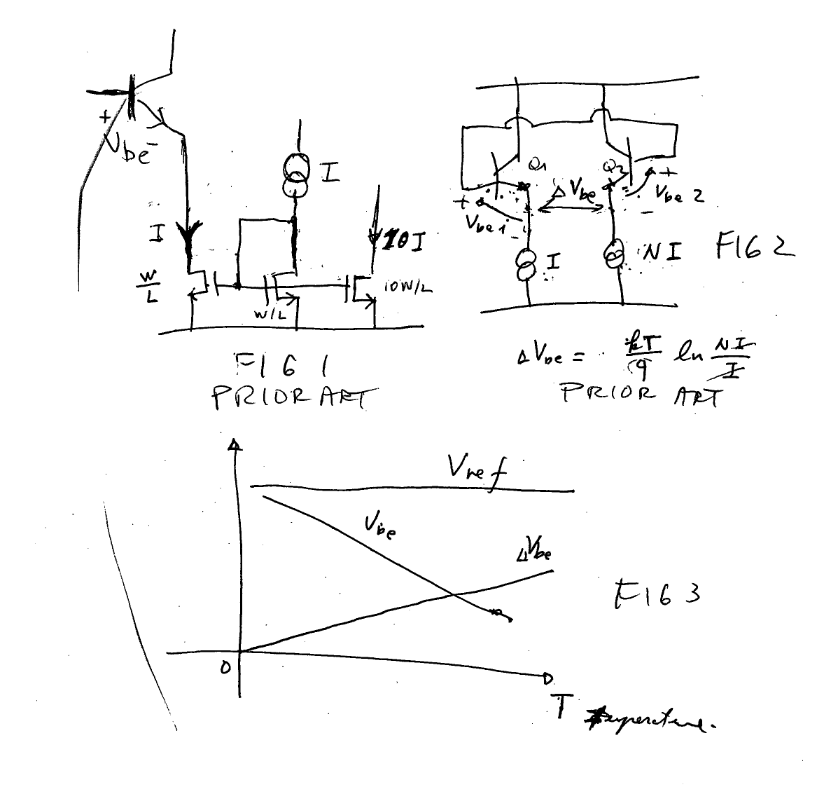

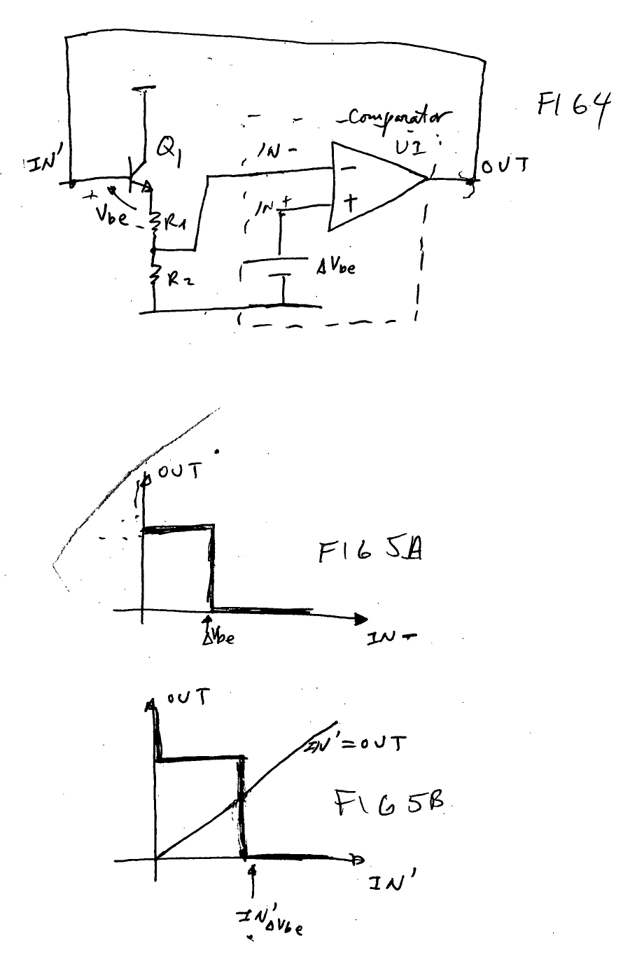

### DETAILED DESCRIPTION OF THE INVENTION

According to the invention, a new implementation for deriving the voltage bandgap reference Vref is provided. As shown in FIG. 4, a bipolar transistor Q1 provides V_{be}. The emitter of the bipolar transistor Q1 is coupled to a resistor divider comprising resistors R1 and R2. The output of the divider is provided to a comparator UI inverting input. The non-inverting input of the comparator U1 is provided to the voltage source comprising ΔV_{be}, which may be generated by the circuit of FIG. 2. The output of the comparator is provided back to the input IN′.

This results in the following equations:

$$IN -= ( {IN}^{′} - {V}_{be} ) x \frac{{R}_{2}}{{R}_{1} + {R}_{2}}$$

$$Δ {V}_{be} = ( {IN}_{Δ V be}^{′} - {V}_{be} ) x \frac{{R}_{2}}{{R}_{1} + {R}_{2}}$$

IN′=OUT

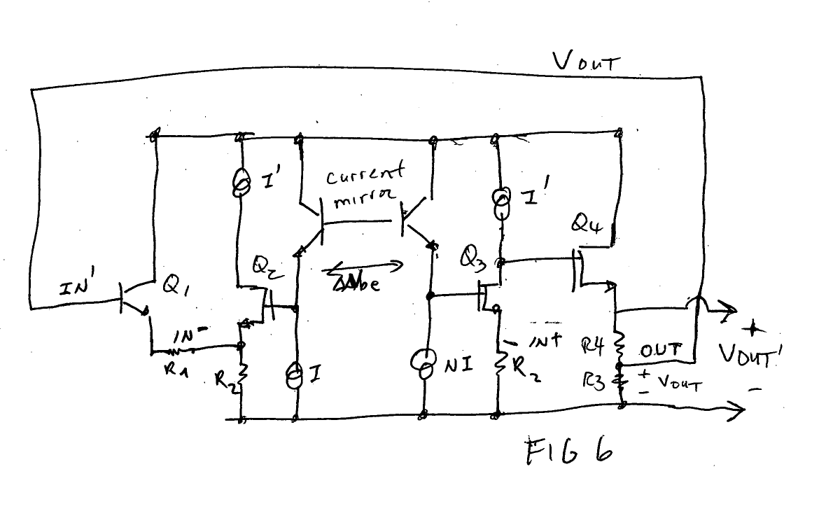

OUT=IN′_{ΔVbe} (from FIG. 5B)

$${IN}_{Δ V be}^{′} = {V}_{be} + \frac{{R}_{1} + {R}_{2}}{{R}_{2}} Δ {V}_{be}$$

$${IN}_{Δ V be}^{′} = OUT = {V}_{be} + \frac{{R}_{1} + {R}_{2}}{{R}_{1}} Δ {V}_{be}$$

The output of the comparator is shown in FIGS. 5A and 5B versus IN—and IN′, respectively. FIG. 5A shows the output versus IN—i.e., versus the input at the inverting input of the comparator. FIG. 5B shows the output versus IN′, i.e., versus the input to the transistor Q1 providing the V_{be} reference voltage. Since the output of the comparator is coupled to the input IN′, the output equals V_{be}+(R₁+R₂)/R₁ ΔV_{be}. Accordingly, the output voltage is a constant voltage equal to V_{be} plus a constant times ΔV_{be}. With the appropriate selection of resistors R1 and R2, the output can remain constant.

FIG. 6 shows a complete circuit implementation where a current mirror circuit has been substituted for ΔV_{be} in FIG. 4. In addition, the comparator has been implemented by FETs Q2, Q3 and Q4 serving as a differential amplifier. The inputs IN− and IN+ are provided respectively at the sources of transistors Q2 and Q3 and the output OUT=V_{REF} is provided at the source of transistor Q4. ΔV_{be} is provided by the current mirror across the gates of the transistors Q2 and Q3. In FIG. 6, a voltage divider comprising resistors R3 and R4 is provided

$${V}_{{out}^{′}} = {V}_{out} ( \frac{{R}_{3} + {R}_{4}}{{R}_{3}} )$$

In this way, the circuit can generate a reference voltage Vout′ that is a multiple of Vout. This is important in applications where a 1.25V reference voltage is too low.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. A bandgap voltage reference circuit comprising:
a first circuit providing a first voltage substantially proportional to V_{be} of a first bipolar transistor;
a second circuit providing a second voltage ΔV_{be} substantially proportional to the difference of two V_{be} voltages of two bipolar transistors; and
a comparator having respective inputs coupled to V_{be} and ΔV_{be} and an output coupled to the base of the first bipolar transistor whereby a voltage substantially proportional to the sum of respective constants multiplying V_{be} and ΔV_{be} is provided at the output of the comparator.

2. A bandgap voltage reference circuit comprising:
a first bipolar transistor providing substantially a reference voltage V_{be};
a current mirror circuit comprising two bipolar transistors coupled in a current mirror arrangement for providing a voltage difference ΔV_{be} comprising substantially a difference signal between the respective V_{be} voltages of the two bipolar transistors; and
a comparator having respective inputs coupled to V_{be} and ΔV_{be} and an output coupled to the base of the first bipolar transistor whereby a voltage substantially proportional to the sum of respective constants multiplying V_{be} and ΔV_{be} is provided at the output of the comparator.

3. A bandgap voltage reference circuit comprising:
a first circuit providing a first voltage substantially proportional to V_{be} of a first bipolar transistor;
a second circuit providing a second voltage ΔV_{be} substantially proportional to the difference of two V_{be} voltages of two bipolar transistors; and
a comparator having respective inputs coupled to V_{be} and ΔV_{be} and an output coupled to the base of the first bipolar transistor whereby a substantially temperature independent voltage refererence is provided at the output of the comparator.
